(19) United States
(12) Patent Application Publication
(10) Pub. No.: US 2014/0003815 A1
(43) Pub. Date: Jan. 2, 2014

(54) Photonic Integrated Circuit Based Phase Conjugation Devices and Methods

(71) Applicant: Pierre Mertz, Baltimore, MD (US)

(72) Inventor: Pierre Mertz, Baltimore, MD (US)

(21) Appl. No.: 13/538,874

(22) Filed: Jun. 29, 2012

(51) Int. Cl. H04B 10/02; H04B 10/06; H04J 14/06

(52) U.S. Cl. 398/65; 398/135; 398/202

(57) ABSTRACT

A photonic integrated circuit device comprises a receiver integrated in a substrate and having an optical input line, a first, a second, a third, and a fourth electrical output line, and a transmitter having a first input line in electrical communication with the first electrical output line, a second input line in electrical communication with the second, a third input line in electrical communication with the third, and a fourth input line in electrical communication with the fourth electrical output line. The receiver may receive and convert an input TM signal, and an input TE signal into a first electrical signal outputted to the first, a second electrical signal outputted to the second, a third electrical signal outputted to the third, and a fourth electrical signal outputted to the fourth electrical output line. The transmitter may receive the electrical signals and modulate and output a phase conjugated output light signal.

### BACKGROUND

An electromagnetic wave, such as a light wave or a light signal, is a vector field that has two primary and orthogonal polarization states or vector directions associated with its propagation. These polarization states are generally referred to as the transverse electric (TE) mode (or signal) and transverse magnetic (TM) mode (or signal) for optical waveguides. The TM signal and the TE signal may be independently modulated to increase the data rate of a light signal.

As a light wave or a light signal is travelling through an optical fiber, imperfections in the optical fiber, such as Kerr nonlinearities and chromatic dispersion, impair the light signal, and in practice limit the distance over which a light signal can be transmitted over an optical fiber without significant degradation or impairment in the signal. The TM signal and the TE signal may be affected differently by the imperfections in the optical fiber, which may cause further degradation of the light signal and further limit the transmission distance. Recent implementations of long-haul optical transmission systems are particularly susceptible to this problem.

Phase conjugation, also referred to as spectral inversion, has received some recent attention as a potential method for increasing signal robustness in long-haul optical transmission systems. Phase conjugation is a complex number operation that reverses the phase response of a light signal by inverting the imaginary part, also referred to as a quadrature (Q) component, of the light signal while the real part, also referred to as the in-phase (I) components of the light signal stays the same. A system employing phase conjugation assumes a symmetrical fiber in terms of power and dispersion profile, and phase conjugates a light signal at about the middle of the optical fiber to reverse the distortions incurred in the first part of the optical fiber by the time the light signal reaches the end of the optical fiber. Impairments that occurred in the first part of the optical fiber may be cancelled by impairments that occur in the second part of the optical fiber, resulting in increased transmission reach.

Several techniques have been proposed to phase conjugate light signals, however, each of the prior art phase-conjugation techniques has drawbacks, such as adding noise to the light signal, requiring decoding and re-coding of the information carried by the light signal, and difficulty integrating and powering the optical phase conjugation components into integrated optic devices, among others.

### SUMMARY OF DISCLOSURE

In one aspect, the disclosure describes a photonic integrated circuit device comprising a substrate, a receiver integrated in the substrate having at least one optical input line, a local oscillator, a first electrical output line, a second electrical output line, a third electrical output line, and a fourth electrical output line, and a transmitter integrated in the substrate having a first input line in electrical communication with the first electrical output line, a second input line in electrical communication with the second electrical output line, a third input line in electrical communication with the third electrical output line, and a fourth input line in electrical communication with the fourth electrical output line, the transmitter having a first optical output line and a second optical output line. The receiver is configured to receive an input light signal having an input TM signal, and input TE signal, and to convert the input light signal into a first electrical signal outputted to the first electrical output line, a second electrical signal outputted to the second electrical output line, a third electrical signal outputted to the third electrical output line, and a fourth electrical signal outputted to the fourth electrical output line. The transmitter is configured to receive the first, second, third, and fourth electrical signals and to modulate a first output light signal with the first electrical signal and the second electrical signal and output a first phase conjugated output light signal on the first optical output line, and to modulate the first output light signal with the third electrical signal and the fourth electrical signal and output a second phase conjugated output light signal on the second optical output line. The first electrical signal comprises information indicative of an I component of the input TM signal, the second electrical signal comprises information indicative of a Q component of the input TM signal, the third electrical signal comprises information indicative of an I component of the input TE signal, and the fourth electrical signal comprises information indicative of a Q component of the input TE signal.

In another aspect, the disclosure describes a photonic integrated circuit device comprising a substrate and a polarization beam splitter configured to split an input light signal into an input TM signal having a first in-phase (I) component and a first quadrature (Q) component, and an input TE signal having a second I component and a second Q component. A first 90° optical hybrid is integrated into the substrate and is optically coupled to the polarization beam splitter, such that the input TM signal may be provided to the first 90° optical hybrid, the first 90° optical hybrid configured to separate the input TM signal into the first I component and the first Q component. A first photodetector is integrated into the substrate in optical communication with the first 90° optical hybrid and is configured to detect the first I component and to output a first electrical signal indicative of the first I component to a first electrical output line. A second photodetector is integrated into the substrate in optical communication with the first 90° optical hybrid and is configured to detect the first Q component and to output a second electrical signal indicative of the first Q component to a second electrical output line. A second 90° optical hybrid is integrated into the substrate and is optically coupled to the polarization beam splitter, such that the input TE signal may be provided to the second 90° optical hybrid, the second 90° optical hybrid configured to separate the input TE signal into the second I component and the second Q component. A third photodetector is integrated into the substrate in optical communication with the second 90° optical hybrid and is configured to detect the second I component and to output a third electrical signal indicative of the second I component to a third electrical output line. A fourth photodetector is integrated into the substrate in optical communication with the second 90° optical hybrid and is configured to detect the second Q component and to output a fourth electrical signal indicative of the second Q component to a fourth electrical output line. A first phase modulator integrated into the substrate has a first Q input electrically coupled with the first electrical output line and a first I input coupled with the second electrical output line, the first phase modulator configured to output a first output light signal having a first output I component and a first output Q component. A second phase modulator is integrated into the substrate and has a second Q input electrically coupled with the third electrical output line and a second I input electrically coupled with the fourth electrical output line, the second phase modulator configured to output a second output light signal having a second output I component and a second output Q component. A polarization beam combiner is optically coupled with the first phase modulator and with the second phase modulator. The polarization beam combiner is configured to combine the first output light signal and the second output light signal into a phase conjugated output light signal. The photonic integrated circuit device is configured to carry out light signal phase conjugation when operably connected to an optical signal transmission link.

In another aspect, the disclosure describes a method comprising operably connecting an optical transmission link to one or more photonic integrated circuit device. The photonic integrated circuit device comprises a substrate, a receiver integrated in the substrate having at least one optical input line, a local oscillator, a first electrical output line, a second electrical output line, a third electrical output line, and a fourth electrical output line, and a transmitter integrated in the substrate in electrical communication with the first, second, third, and fourth electrical output lines and having a first optical output line and a second optical output line. The receiver is configured to receive an input light signal having an input TM signal, and input TE signal, and to convert the input light signal into a first electrical signal outputted to the first electrical output line, a second electrical signal outputted to the second electrical output line, a third electrical signal outputted to the third electrical output line, and a fourth electrical signal outputted to the fourth electrical output line. The transmitter is configured to receive the first, second, third, and fourth electrical signals and to modulate a first output light signal with the first electrical signal and the second electrical signal and output a first phase conjugated output light signal on the first optical output line, and to modulate the first output light signal with the third electrical signal and the fourth electrical signal and output a second phase conjugated output light signal on the second optical output line.

In yet another aspect, the disclosure describes a method, comprising receiving a TM component and a TE component of an input light signal by a receiver of a photonic integrated circuit device, phase conjugating the input light signal to create a phase conjugated output light signal by a transmitter of the photonic integrated circuit device, and outputting the phase conjugated output light signal.

### BRIEF DESCRIPTION OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings, and appendices. In the drawings:

FIG. 1 is a diagram of an exemplary embodiment of a wave division multiplexing optical system including a photonic integrated circuit based device according to the disclosure.

FIG. 2 is a diagram of a photonic integrated circuit based phase conjugation device according to the disclosure, shown connected to an optical transmission link.

FIG. 3 is a diagram of an exemplary embodiment of a photonic integrated circuit based phase conjugation device according to the disclosure.

### DETAILED DESCRIPTION

Before explaining at least one embodiment of the disclosure, it is to be understood that the disclosure is not limited in its application to the details of construction and the arrangement of the components or steps or methodologies set forth in the following description or illustrated in the drawings. Embodiments of the disclosure may be practiced or carried out in various ways. Also, it is to be understood that the phraseology and terminology employed herein is for the purpose of description and should not be regarded as limiting.

In the following detailed description of embodiments of the disclosure, numerous specific details are set forth in order to provide a more thorough understanding. However, it will be apparent to one of ordinary skill in the art that the embodiments may be practiced without these specific details. In other instances, well-known features have not been described in detail to avoid unnecessarily complicating the instant disclosure.

As used herein the notations “1-n” and “a-n” appended to a reference numeral or symbol are intended as merely convenient shorthand to reference one, or more than one, and up to infinity, of the element or feature identified by the respective reference numeral or symbol (e.g., 100a-n, λ₁₋ₙ). Similarly, a letter following a reference numeral or symbol is intended to reference an embodiment of the feature or element that may be similar, but not necessarily identical, to a previously described element or feature bearing the same reference numeral (e.g., 100, 100a, 100b, λ₁, etc.). Such shorthand notations are used for purposes of clarity and convenience only, and should not be construed to limit the disclosure in any way, unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

As used herein the qualifiers “about,” “approximately,” and “substantially” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example.

Further, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

In addition, use of the “a” or “an” are employed to describe elements and components of the embodiments disclosed herein. This is done merely for convenience and to give a general sense of the embodiments. This description should be read to include one or more and the singular also includes the plural unless it is obvious that it is meant otherwise.

Finally, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The disclosure is generally directed to a photonic integrated circuit based phase conjugation device, and more particularly, but not by way of limitation, to a photonic integrated circuit phase conjugation device that can be used to extend transmission reach of an optical transmission link by mid-link phase conjugation via coherent detection and I/Q modulation. A photonic integrated circuit based phase conjugation device according to the disclosure may be implemented at about the middle of an optical transmission link to increase the transmission reach of the optical transmission link by separating the light signal into a TM signal and a TE signal, detecting the I component and the Q component of the TM signal and the I component and the Q component of the TE signal, and by transmitting a phase conjugated output light signal which has the I component and the Q component of the TM signal swapped relative to the input light signal, and the I component and the Q component of the TE signal swapped relative to the input light signal. As the phase-conjugated output light signal travels through a second part of the optical transmission link, impairments that were incurred by the input light signal in a first part of the optical transmission link may be cancelled by impairments incurred by the phase conjugated output light signal in the second part of the optical transmission link, resulting in increased transmission reach.

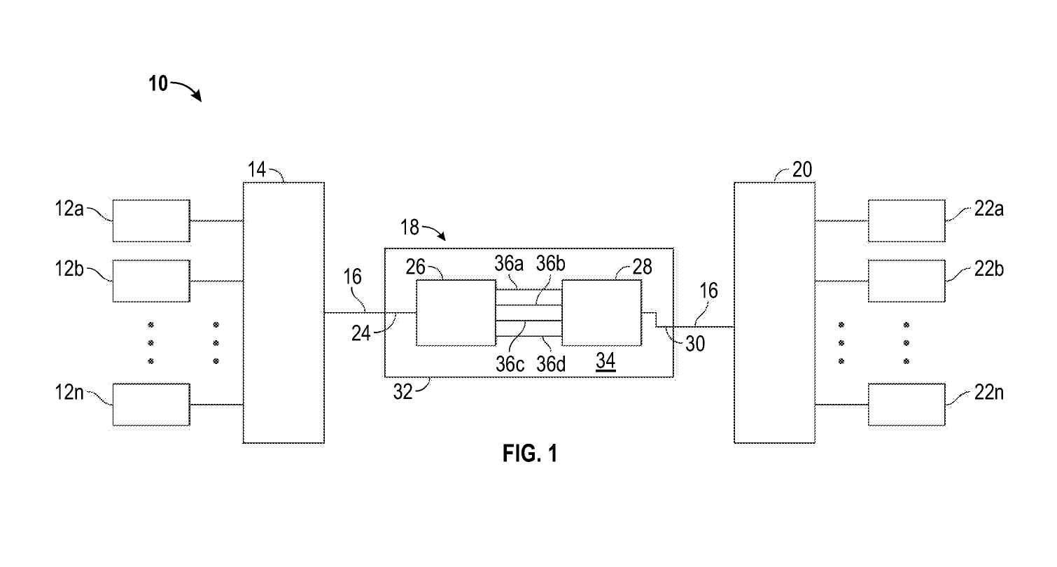

Referring now to FIG. 1, shown therein is an exemplary embodiment of a wave division multiplexing optical system 10 including transmitters 12a-n, a wavelength division multiplexer 14, an optical transmission link 16, a photonic integrated circuit (PIC) based phase conjugation device 18, a wavelength division demultiplexer 20, and receivers 22a-n, for example. It is to be understood that one, more than one, and up to a plurality of the above elements may be used in some exemplary embodiments of a wave division multiplexing system.

Each of the transmitters 12a-n may include a laser and an optical modulator to provide each of a corresponding one of a plurality of light or optical signals, each of which having a respective one of a plurality of wavelengths (λ₁ to λₙ). Each light signal may include a first portion having a first polarization, e.g., a transverse electric (TE) polarization, and a second portion having a second polarization, e.g., a transverse magnetic (TM) polarization. The first and second portions may be modulated independently to carry separate data streams. Moreover, the first and second portions of each optical signal may be further modulated to have I and Q components, which in turn may carry different data streams. Each optical signal may be fed to the wavelength division multiplexer 14, to combine the optical signals and provide the resulting combined optical signal onto the optical transmission link 16, which may include an optical fiber, for example.

As further shown in FIG. 1, a PIC-based phase conjugation device 18 may be provided along the optical transmission link 16.

The PIC-based phase conjugation device 18 may include an optical input line 24, a receiver 26, a transmitter 28, and an optical output line 30, integrated into and/or supported by a substrate 32.

The substrate 32 may be implemented as any suitable material or combinations of materials, such as indium phosphide, gallium arsenide, lithium niobate, and/or silicon, for example. The substrate 32 may be configured to allow for the integration of the various optical and/or electrical components of the PIC-based phase conjugation device 18 as will be described herein below. The substrate 32 is provided with a surface 34 onto which the optical input line 24, the receiver 26, the transmitter 28, and the optical output line 30 are positioned.

The optical input line 24 may be in optical communication with the optical transmission link 16, and may be configured to transmit or otherwise provide an input light signal having an input TM signal and an input TE signal from any suitable source to the receiver 26. For example, the optical input line 24 may be formed as an optical waveguide. As will be understood by a person of ordinary skill in the art, the input light signal may have a first wavelength, a first phase, and a first amplitude, for example.

The receiver 26 may be in optical communication with the optical input line 24 and may include one or more optional polarization beam splitter (not shown), one or more optional hybrid splitter (not shown), one or more local oscillator, such as a laser (not shown), and one or more detector (not shown) configured to detect an amplitude and phase of a first aspect and a second aspect of the input TM signal and/or a third aspect and a fourth aspect of the input TE signal of the input light signal, and to output an electrical output signal indicative of the first, second, third, and fourth aspect of the input light signal. Four electrical output lines 36a-d may be in electrical communication with the receiver 26.

The transmitter 28 may be in electrical communication with the receiver 26 via a first electrical output line 36a, a second electrical output line 36b, a third electrical output line 36c, and a fourth electrical output line 36d. In one exemplary embodiment, the first electrical output line 36a may carry a first electrical signal indicative of the first aspect of the input light signal, the second electrical output line 36b may carry a second electrical signal indicative of the second aspect of the input light signal, the third electrical output line 36c may carry a third electrical signal indicative of the third aspect of the input light signal, and the fourth electrical output line 36d may carry a fourth electrical signal indicative of the fourth aspect of the input light signal.

The first electrical signal, the second electrical signal, the third electrical signal, and the fourth electrical signal may be received by the transmitter 28 and may be used to modulate an output light signal. The output light signal may be phase conjugated relative to the input light signal. The first electrical signal may be indicative of an I component of the input TM signal. The second electrical signal may be indicative of a Q component of the input TM signal. The third electrical signal may be indicative of an I component of the input TE signal. The fourth electrical signal may be indicative of a Q component of the input TE signal.

The transmitter 28 may include a dual polarization I/Q modulator capable of receiving the first, the second, the third, and the fourth electrical signals, and outputting a first output light signal and a second output light signal that are phase conjugated with respect to the input light signal. The first output light signal and the second output light signal may be phase conjugated by using the first electrical signal indicative of the I component from the input TM signal to modulate the Q component of the first output light signal, using the second electrical signal indicative of the Q component from the input TM signal to modulate the I component of the first output light signal, using the third electrical signal indicative of the I component from the input TE signal to modulate the Q component of the second output light signal, and using the fourth electrical signal indicative of the Q component from the input TE signal to modulate the I component of the second output light signal, for example.

The transmitter 28 may include a polarization beam combiner (not shown) to combine the first output light signal and the second output light signal into one or more phase conjugated output light signal, for example. In some exemplary embodiments, the first output light signal may be a TE signal or a TM signal, and the second output light signal may be a TE signal or a TM signal, and combinations thereof. As will be understood by persons of ordinary skill in the art, the polarization of the first output light signal or the polarization of the second output light signal may be rotated ninety degrees by a rotator (not shown) which may be implemented as a separate component, or may be combined with the polarization beam combiner (not shown), such that the one or more phase conjugated output signal has both a TE signal and a TM signal, for example.

The one or more phase conjugated output light signal may then exit the PIC-based phase conjugation device 18 via the optical output line 30, and may be transmitted to and/or through the optical transmission link 16, for example.

As noted above, the input light signal may include multiple wavelengths, such as λ₁-λ₁₀, each having a TE and TM components, and each TE and TM component having I and Q components. Each optical signal is multiplexed onto optical transmission link 16 and is transmitted to the wavelength division demultiplexer 20.

The wavelength division demultiplexer 20 may be configured such that the wavelength division demultiplexer 20 may demultiplex a multiplexed light signal into demultiplexed light signals and may output such demultiplexed light signals to the receivers 22a-n, for example.

The receivers 22a-n may be capable of receiving a light signal from the optical transmission link 16 and demodulating and/or re-transmitting the light signal, for example.

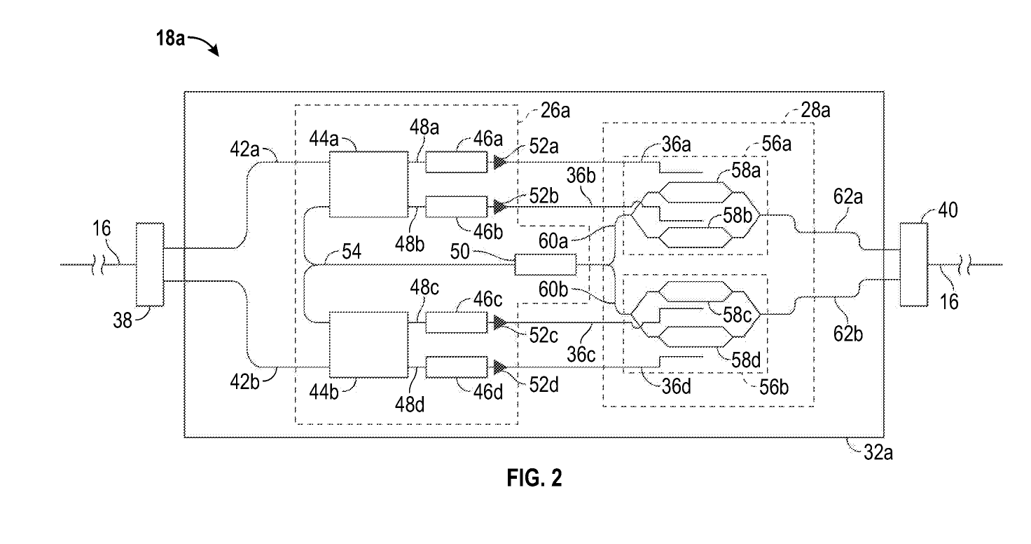

Referring now to FIG. 2, an exemplary embodiment of a phase conjunction system including PIC-based phase conjugation device 18a a polarization beam splitter 38 and a polarization beam combiner 40 is shown. The PIC-based phase conjugation device 18a may include a polarization beam splitter 38, a receiver 26a, a transmitter 28a, and a polarization beam combiner 40, integrated on or supported by a substrate 32a. The PIC-based phase conjugation device 18a is similar in functionality as the PIC-based phase conjugation device 18 with the exception that the PIC-based phase conjugation device 18a is configured to work in the phase conjugation system in which the polarization beam splitter 38 and the polarization beam combiner 40 are separate from the PIC-based phase conjugation device 18a, or differently therefrom, for example.

The substrate 32a may be implemented similarly to the substrate 32 described above, and may be structured to allow for the integration of the various optical and/or electrical components of the PIC-based phase conjugation device 18a as will be described herein below.

The PIC-based phase conjugation device 18a will be described herein with respect to an input light signal including a single wavelength λ.

The polarization beam splitter 38 may be configured to separate the TE signal (part, component) and the TM signal (part, component) of an input light signal from one another into an input TM signal and an input TE signal, for example. The polarization beam splitter 38 may be in optical communication with an incoming optical transmission link 16, which may allow for an input light signal to be transmitted to, or otherwise provided to, the polarization beam splitter 38, for example.

It is to be understood that while the polarization beam splitter 38 is not shown in FIG. 2 as being integrated in the substrate 32a, in the embodiment of FIG. 1, the polarization beam splitter is integrated into the receiver 26 and on the substrate 32.

The PIC-based phase conjugation device 18a has a first waveguide or optical signal line 42a and a second optical signal line 42b, which may supply the TE signal and TM signal components of the light signal, respectively, to the receiver 26a.

The receiver 26a may include a first 90° optical hybrid 44a in optical communication with a first photodetector 46a via an optical signal line 48a and in optical communication with a second photodetector 46b via an optical signal line 48b, a second 90° optical hybrid 44b in optical communication with a third photodetector 46c via an optical signal line 48c, and in optical communication with a fourth photodetector 46d via an optical signal line 48d, for example. The receiver 26a may also include a local oscillator 50, such as a laser, in optical communication with the first 90° optical hybrid 44a and in optical communication with the second 90° optical hybrid 44b. The receiver 26a may also include a first electrical signal amplifier 52a in electrical communication with the first photodetector 46a, a second electrical signal amplifier 52b in electrical communication with the second photodetector 46b, a third electrical signal amplifier 52c in electrical communication with the third photodetector 46c, and a fourth electrical signal amplifier 52d in electric communication with the fourth photodetector 46d, for example.

The first 90° optical hybrid 44a may be in optical communication with the polarization beam splitter 38 via the optical signal line 42a, such that the input TM signal of the input light signal may be transmitted or otherwise provided to the first 90° optical hybrid 44a, for example. The first 90° optical hybrid 44a may be implemented as a 90° optical hybrid splitter configured to split the input TM signal into an I component and a Q component, as will be understood by persons of ordinary skill in the art. The I component of the input TM signal may have a first amplitude and a first phase, and the Q component of the input TM signal may have a second amplitude and a second phase. In some exemplary embodiments disclosed herein the first amplitude may be similar to, different from, or substantially equal to the second amplitude, the first phase may be similar to, different from, or substantially the same as the second phase, and combinations thereof.

The first 90° optical hybrid 44a is in optical communication with the local oscillator 50 via an optical signal line 54, such that light signals provided by the local oscillator 50 may be mixed with the I component and the Q component from the input TM signal of the input light signal, for example.

The local oscillator 50 may be implemented as a light signal source, such as a laser, capable of generating and outputting a light signal that may have any desired wavelength and power, as will be understood by persons of ordinary skill in the art. For example, the power and wavelength of the light signal outputted by the local oscillator 50 may be closely matched, or substantially equal to the wavelength of the input light signal in some embodiments disclosed herein. The local oscillator 50 may allow the receiver 26a to function as a coherent receiver, whereby the light signal provided by the local oscillator 50 may be mixed with the input TM signal of the input light signal by the first 90° optical hybrid 44a and with the TE signal of the input light signal by the second 90° optical hybrid 44b, as will be understood by a person of ordinary skill in the art, for example. A suitable electrical power source (not shown) may be operatively connected to the local oscillator 50, for example.

The first 90° optical hybrid 44a may be in optical communication with the first photodetector 46a via the optical signal line 48a, such that a light signal indicative of, representative of, or corresponding to the I component of the input TM signal may be transmitted to, or otherwise provided to the first photodetector 46a via the optical signal line 48a.

The first 90° optical hybrid 44a may further be in optical communication with the second photodetector 46b via the optical signal line 48b, such that a light signal indicative of the Q component of the input TM signal may be transmitted to, or otherwise provided to the second photodetector 46b via the optical signal line 48b, for example.

The first photodetector 46a and the second photodetector 46b serve to convert a light signal to an electrical signal, and may be implemented as a balanced photodetector, or a single-ended photodetector (in some exemplary embodiments where the power of the local oscillator 50 may be about 10 dB higher than power of the input light signal), configured to detect the amplitude or phase of an incoming light signal, and to output an electrical signal indicative of, representative of, or corresponding to, the amplitude and/or phase of the detected light signal. The first photodetector 46a may be configured to detect the first amplitude and the first phase of the I component of the input TM signal from the first 90° optical hybrid 44a, and to output a first electrical signal representative of, indicative of, or corresponding to the I component of the input TM signal, for example. The second photodetector 46b may be configured to detect the second amplitude and/or the second phase of the Q component of the input TM signal from the first 90° optical hybrid 44a, and to output a second electrical signal representative of, indicative of, or corresponding to, the Q component of the input TM signal, for example.

The first photodetector 46a and the second photodetector 46b may be implemented similarly to one another, differently from one another, or may be substantially identical to one another, and combinations thereof, as will be understood be a person of ordinary skill in the art having the benefit of the instant disclosure. A suitable electrical power source (not shown) may be operably coupled with the first photodetector 46a and the second photodetector 46b, as will be understood by persons of ordinary skill in the art, for example.

It is to be understood that while the first photodetector 46a is described as detecting the I component of the input TM signal, and the second photodetector 46b is described as detecting the Q component of the input TM signal, some embodiments may include the first photodetector 118a and the second photodetector 46b receiving or detecting the I component of the input TM signal, the Q component of the input TM signal, the I component of the input TE signal, the Q component of the input TE signal, and combinations thereof, for example.

The optical signal line 48a and the optical signal line 48b may be implemented as any optical signal line capable of carrying a light signal therein, such as a waveguide, and may be implemented similarly to one another, differently from one another, identical to one another, and combinations thereof, for example.

The first electrical signal amplifier 52a may be implemented as a trans-impedance amplifier (TIA), for example, and may be electrically connected with the first photodetector 46a, and the second electrical signal amplifier 52b may be electrically connected with the second photodetector 46b, such that the first electrical signal outputted by the first photodetector 46a and/or the second electrical signal outputted by the second photodetector 46b may be filtered, amplified, or otherwise processed by the first electrical signal amplifier 52a and/or the second electrical signal amplifier 52b, respectively, for example. The first electrical signal amplifier 52a may output a first electrical signal via a first electrical output line 36a, and the second electrical signal amplifier 52b may output a second electrical signal via a second electrical output line 36b, for example.

It is to be understood that while the first electrical signal amplifier 52a and the second electrical signal amplifier 52b are shown as being integrated in the substrate 32a of the phase conjugation device 18a, in some exemplary embodiments, the first electrical signal amplifier 52a and the second electrical signal amplifier 52b may be physically separate devices from the phase conjugation device 18a and may be electrically and/or physically connected to the phase conjugation device 18a in any suitable manner, such as via wire bonding, as will be understood by persons of ordinary skill in the art. Further, in some exemplary embodiments, one or both of the electrical signal amplifier 52a and the electrical signal amplifier 52b may be omitted, and the first electrical signal outputted by the first photodetector 46a and/or the second electrical signal outputted by the second photodetector 46b may not be amplified and/or may not be processed, for example.

The optical signal line 42b may optically connect the polarization beam splitter 38 and the second 90° optical hybrid 44b, such that a light signal indicative of the input TE signal separated by the polarization beam splitter 38 may be provided or transmitted to the second 90° optical hybrid 44b via the optical signal line 42b. The optical signal line 42b may be implemented similarly to the optical signal line 42a, for example.

The second 90° optical hybrid 44b may be implemented and may function similarly to, or differently from, the first 90° optical hybrid 44a, and may split the input TE signal into an I component and a Q component, as will be understood by persons of ordinary skill in the art. The I component of the input TE signal may have a third amplitude and a third phase, and the Q component of the input TE signal may have a fourth amplitude and a fourth phase, for example. In some exemplary embodiments, the third amplitude may be similar to, different from, or substantially equal to the fourth amplitude, for example. Further, in some exemplary embodiments, the third phase may be similar to, different from, or substantially the same as the fourth phase. Further, the third amplitude may be similar to, substantially equal to, or different from the second amplitude, and the third phase may be similar to, substantially the same as, or different from the first phase, for example, and combinations thereof.

The second 90° optical hybrid 44b may be in optical communication with the local oscillator 50, such that the local oscillator 50 may provide a light signal which may be mixed with the input TE signal by the second 90° optical hybrid 44b as described above, for example.

It is to be understood that while the first 90° optical hybrid 44a is described herein as receiving the input TM signal, and the second 90° optical hybrid 44b is described as receiving the input TE signal, the embodiments disclosed herein may be implemented with the first 90° optical hybrid 44a receiving the input TE signal and the second 90° optical hybrid 44b receiving the input TM signal, for example.

The second 90° optical hybrid 44b may be in optical communication with the third photodetector 46c via an optical signal line 48c, such that the I component of the input TE signal may be detected by the third photodetector 46c via the optical signal line 48c, for example. The second 90° optical hybrid 44b is further in optical communication with the fourth photodetector 46d via an optical signal line 48d, such that the Q component of the input TE signal may be detected by the fourth photodetector 46d via the optical signal line 48d, for example.

The third photodetector 46c and the fourth photodetector 46d may be implemented similarly to, or differently from the first photodetector 46a and/or the second photodetector 46b. The third photodetector 46c may be configured to detect the third amplitude and the third phase of the I component of the input TE signal from the second 90° optical hybrid 44b, and to output a third electrical signal representative of, indicative of, or corresponding to, the I component of the input TE signal, for example. The fourth photodetector 46 may be configured to detect the fourth amplitude and the fourth phase of the Q component of the input TE signal from the second 90° optical hybrid 44b, and to output a fourth electrical signal representative of, indicative of, or corresponding to, the Q component of the input TE signal. A suitable electrical power source (not shown) may be operatively coupled with the third photodetector 46c and/or the fourth photodetector 46d, for example.

It is to be understood that while the third photodetector 46c is described as receiving the I component of the input TE signal, and the fourth photodetector 46d is described as receiving the Q component of the input TE signal, some embodiments disclosed herein may include the third photodetector 118c and the fourth photodetector 46d receiving the I component of the input TM signal, the Q component of the input TM signal, the I component of the input TE signal, the Q component of the input TE signal, and combinations thereof, for example.

The optical signal line 48c and the optical signal line 48d may be implemented similarly to the optical signal line 48a, for example.

The third electrical signal amplifier 52c may be electrically connected with the third photodetector 46c, and the fourth electrical signal amplifier 52d may be electrically connected with the fourth photodetector 46d, such that the third electrical signal generated by the third photodetector 46c and/or the fourth electrical signal generated by the fourth photodetector 46d may be filtered, amplified, or otherwise processed by the third electrical signal amplifier 52c and by the forth electrical signal amplifier 52d, respectively, for example. The third electrical signal amplifier 52c may output a third electrical signal via a third electrical output line 36c, and the fourth electrical signal amplifier 52d may output a fourth electrical signal via a fourth electrical output line 36d, for example.

Further, in some exemplary embodiments, one or both of the third electrical signal amplifier 52c and the fourth electrical signal amplifier 52d may be omitted, and the third electrical signal generated by the third photodetector 46c and/or the fourth electrical signal generated by the fourth photodetector 46d may not be amplified and/or may not be processed, for example. A suitable electrical power source (not shown) may be operatively coupled with the first electrical signal amplifier 52a, the second electrical signal amplifier 52b, the third electrical signal amplifier 52c, and the fourth electrical signal amplifier 52d, for example.

The transmitter 28a may include a first phase modulator 56a and a second phase modulator 56b.

The first phase modulator 56a may be implemented as a using dual-polarization I/Q phase modulator 56a capable of phase modulating a light signal, one or more pairs of nested Mach-Zehnder dual-polarization modulators 58a and 58b, for example. The first phase modulator 56a may have a Q input electrically coupled with the first electrical signal amplifier 52a via the first electrical output line 36a and an I input electrically coupled with the second electrical signal amplifier 52b via the second electrical output line 36b, such that the first electrical signal outputted by the first photodetector 46a and/or processed by the first electrical signal amplifier 52a may be provided to the Q input of the first phase modulator 56a, and the second electrical signal outputted by the second photodetector 46b and/or processed by the second electrical signal amplifier 52b may be provided to the I input of the first phase modulator 56a, for example.

As will be appreciated by a person of ordinary skill in the art, in some exemplary embodiments, the first electrical signal amplifier 52a and/or the second electrical signal amplifier 52b may be omitted, and the first electrical output line 36a may be used to transmit the first electrical signal from the first photodetector 46a to the Q input of the first phase modulator 56a and/or the second electrical output line 36b may be used to transmit the second electrical signal from the second photodetector 46b to the I input of the first phase modulator 56a, for example.

The first phase modulator 56a may further be optically coupled with the local oscillator 50 via an optical signal line 60a, such that a light signal generated by the local oscillator 50 may be provided to the first phase modulator 56a via the optical signal line 60a, for example.

A light signal generated by the local oscillator 50 and provided to the first phase modulator 56a via the optical signal line 60a may be I/Q modulated with the first electrical signal from the first photodetector 46a and/or with the second electrical signal from the second photodetector 46b, such that a first output light signal including an I component having the first amplitude or the first phase and a Q component having the second amplitude or the second phase is outputted by the first phase modulator 56a. The first phase modulator 56a may swap the I component and the Q component of the input TM signal, such as by using the first electrical signal indicative of the I component from the input TM signal to modulate the Q component of the first output light signal, and by using the second electrical signal indicative of the Q component from the input TM signal to modulate the I component of the first output light signal, for example. The swapped, switched, or inverted I component and Q component may then be combined in the first output light signal by the first phase modulator 56a, which first output light signal may be provided to an optical signal line 62a, for example. The first output light signal may be a TM signal or a TE signal, and combinations thereof, for example.

As will be understood by persons of ordinary skill in the art, the first phase modulator 56a may be in optical communication with a light signal source (not shown) and may or may not be in optical communication with the local oscillator 50 in some exemplary embodiments, such that a light signal generated by the light signal source (not shown) may be provided to the first phase modulator 56, and may be modulated by the first phase modulator 56a as described above, for example. The light signal provided by the light signal source (not shown) may have a wavelength substantially similar to the wavelength of the light signal provided by the local oscillator 50, for example.

The second phase modulator 56b may be implemented similarly to the first phase modulator 56a, and may function similarly, or differently therefrom, for example. The second phase modulator 56b may include one or more pairs of nested Mach-Zehnder dual-polarization modulators 58c and 58d, in some embodiments of the disclosure, for example.

The second phase modulator 56b may be electrically connected to the third electrical signal amplifier 52c via the third electrical output line 36c and to the fourth electrical signal amplifier 52d via the fourth electrical output line 36d, such that the third electrical signal outputted by the third photodetector 46c and/or processed by the third electrical signal amplifier 52c may be provided to a Q input of the second phase modulator 56b, and the fourth electrical signal outputted by the fourth photodetector 46d and/or processed by the fourth electrical signal amplifier 52d may be provided to an I input of the second phase modulator 56b.

As will be appreciated by a person of ordinary skill in the art, in some exemplary embodiments disclosed herein, the third electrical signal amplifier 52c and/or the fourth electrical signal amplifier 52d may be omitted, and the third electrical output line 36c may be used to transmit the third electrical signal from the third photodetector 46c to the Q input of the second phase modulator 56b and/or the fourth electrical output line 36d may be used to transmit the fourth electrical signal from the fourth photodetector 46d to the I input of the second phase modulator 56b, for example.

A light signal generated by the local oscillator 50 may be provided to the second phase modulator 56b via an optical signal line 60b and may be phase modulated with the third electrical signal from the third photodetector 46c and/or the fourth electrical signal from the fourth photodetector 46d such that a second output light signal including an I component having the third amplitude or the third phase and a Q component having the fourth amplitude or the fourth phase is outputted by the second phase modulator 56b. The second phase modulator 56b may swap the I component and the Q component relative to the input TE signal, such as by using the third electrical signal indicative of the I component from the input TE signal to modulate the Q component of a second output light signal, and by using the fourth electrical signal indicative of the Q component from the input TE signal to modulate the I component of the second output light signal. The swapped, switched, or inverted I component and Q component may then be combined in the second output light signal by the second phase modulator 56b, which second output light signal may be provided to an optical signal line 62b, for example. The second output light signal may be a TM signal or a TE signal, and combinations thereof, for example.

As will be understood by persons of ordinary skill in the art, the second phase modulator 56b may be in optical communication with a light signal source (not shown) and may or may not be in optical communication with the local oscillator 50 in some exemplary embodiments disclosed herein, such that a light signal generated by the light signal source (not shown) may be provided to the second phase modulator 56b, and may be modulated by the second phase modulator 56b as described above, for example. The light signal provided by the light signal source (not shown) may have a wavelength substantially similar to the wavelength of the light signal provided by the local oscillator 50, for example.

The first phase modulator 56a and the second phase modulator 56b may be operatively connected to one or more suitable power source (not shown) as will be understood by persons of ordinary skill in the art, for example.

The polarization beam combiner 40 may be implemented as any polarization beam combiner configured to combine the TM signal and the TE signal of a light signal, for example. The polarization beam combiner 40 may be in optical communication with the optical signal line 62a and with the optical signal line 62b, for example. The polarization beam combiner 40 may receive the first output light signal from the first phase modulator 56a via the optical signal line 62a. A rotator (not shown), such as a 90° twist in the optical signal line 62a, which may be implemented as a polarization-maintaining optical fiber, for example, may rotate the polarization of the first output light signal 90 degrees to convert the first output light signal into an output TM signal as needed, for example. The polarization beam combiner 40 may likewise receive the second output light signal from the second phase modulator 56b via the optical signal line 62b, for example. The polarization beam combiner 40 may combine the first output light signal and the second output light signal into a phase conjugated output light signal that may be outputted to the optical transmission link 16, for example.

It is to be understood that while the polarization beam combiner 40 is shown as being separate from the substrate 32a, in some exemplary embodiments of the disclosure, the polarization beam combiner 40 may be integrated into the substrate 32a.

In operation, a PIC-based phase conjugation device 18a according to the embodiments disclosed herein may operate as follows. The phase conjugation device 18a may be optically connected to the optical transmission link 16, such as an optical fiber, in any suitable manner, for example.

An input light signal may be transmitted to the polarization beam splitter 38 from the optical transmission link 16, for example. The polarization beam splitter 38 may split the incoming light signal into an input TM signal and an input TE signal. The input TM signal may be provided to the first 90° optical hybrid 44a via the optical signal line 42a, and the input TE signal may be provided to the second 90° optical hybrid 44b via the optical signal line 42b, for example.

The first 90° optical hybrid 44a may split the input TM signal into an I component and a Q component, and may provide the I component to the first photodetector 46a via the optical signal line 48a, and the Q component to the second photodetector 46b via the optical signal line 48b, for example.

The first photodetector 46a may output a first electrical signal indicative of the I component of the input TM signal, which first electrical signal may be amplified or processed by the electrical signal amplifier 52a, for example. Similarly, the second photodetector 46b may output a second electrical signal indicative of the Q component of the input TM signal, which second electrical signal may be amplified or processed by the electrical signal amplifier 52b, for example.

The second 90° optical hybrid 44b may split the input TE signal into an I component and a Q component, and may provide the I component to the third photodetector 46c via the optical signal line 48c, and the Q component to the fourth photodetector 46d via the optical signal line 48d, for example.

The third photodetector 46c may output a third electrical signal indicative of the I component of the input TE signal, which third electrical signal may be amplified or processed by the third electrical signal amplifier 52c, for example. Similarly, the fourth photodetector 46d may output a fourth electrical signal indicative of the Q component of the input TE signal, which fourth electrical signal may be amplified or processed by the fourth electrical signal amplifier 52d, for example.

The first electrical signal may be provided to the Q input of the first phase modulator 56a and the second electrical signal may be provided to the I input of the first phase modulator 56a. The first electrical signal representative of the I component from the input TM signal may be used to modulate the Q component of a first output signal and the second electrical signal indicative of the Q component from the input TM signal may be used to modulate an I component of the first output signal, such that the I component and the original Q component are swapped with one another relative to the input TM signal. The swapped I component and Q component may be combined into the first output light signal. The first output light signal may be a TM signal or a TE signal, for example.

The third electrical signal may be provided to the Q input of the second phase modulator 56b and fourth electrical signal may be provided to the I input of the second phase modulator 56b. The third electrical signal indicative of the I component of the input TE signal may be used to modulate a Q component of a second output light signal and the fourth electrical signal indicative of the Q component of the input TE signal may be used to modulate an I component of the second output light signal, such that the original I component and the original Q component are swapped with one another relative to the input TE signal. The swapped I component and Q component may be combined into the second output light signal. The second output light signal may be a TM signal and/or a TE signal, for example.

Swapping the I component and the Q component in both of the TE and the TM signals results in a phase conjugation of the input light signal. Thus, the Q component of a TE signal output from the PIC-based phase conjugation device 18a is modulated to carry data that was carried by the I component of a corresponding TE signal input to the PIC-based phase conjugation device 18a, and the I component of the TE signal output from the PIC-based phase conjugation device 18a is modulated to carry data that was carried by the Q component of the corresponding TE signal input to PIC-based phase conjugation device 18a.

The first output light signal and the second output light signal may be combined by the polarization beam combiner 40 into a phase conjugated output light signal. In some exemplary embodiments, the first output light signal may be a TE signal and the second output light signal may be a TE signal, in which case the polarization of the first output light signal or the polarization of the second output light signal may be rotated ninety degrees prior to the polarization beam combiner 40 as described above, such that the first output light signal is converted to a TM signal, or alternatively the second output light signal is converted to a TM signal, for example and the combiner. The phase conjugated output light signal may be transmitted back into the optical transmission link 16, for example.

As the phase conjugated output light signal travels through a second part of the optical transmission link 16, impairments incurred by the input light signal as the input light signal traveled through a first part of the optical transmission link 16 are cancelled out by impairments incurred by the phase conjugated output light signal as it travels through the second part of the optical transmission link 16, thus providing increased transmission reach.

As will be appreciated by persons of ordinary skill in the art, the phase conjugation of the input light signal with the PIC-based phase conjugation device 18a as described above may function to extend the reach of the optical transmission link 16 beyond the reach of a light signal that has not been conjugated. Further, the PIC-based phase conjugation device 18a may be connected at any location along the optical transmission link 16 varying from a start to an end thereof. In some exemplary embodiments, the PIC-based phase conjugation device 18a may be connected between about ten percent and about ninety percent of the length of the optical transmission link 16. In other exemplary embodiments, the PIC-based phase conjugation device 18a may be connected between about thirty percent and about sixty percent of the length of the optical transmission link 16, between about twenty-five percent and about seventy-five percent of the length of the optical transmission link 16, between about forty percent and about sixty percent of the length of the optical transmission link 16, at about fifty percent of the length of the optical transmission link 16, and various combinations thereof. Further in some exemplary embodiments, one or more, two or more, three or more, or four or more PIC-based phase conjugation devices 18a may be operably connected with one, or more than one, optical transmission link 16.

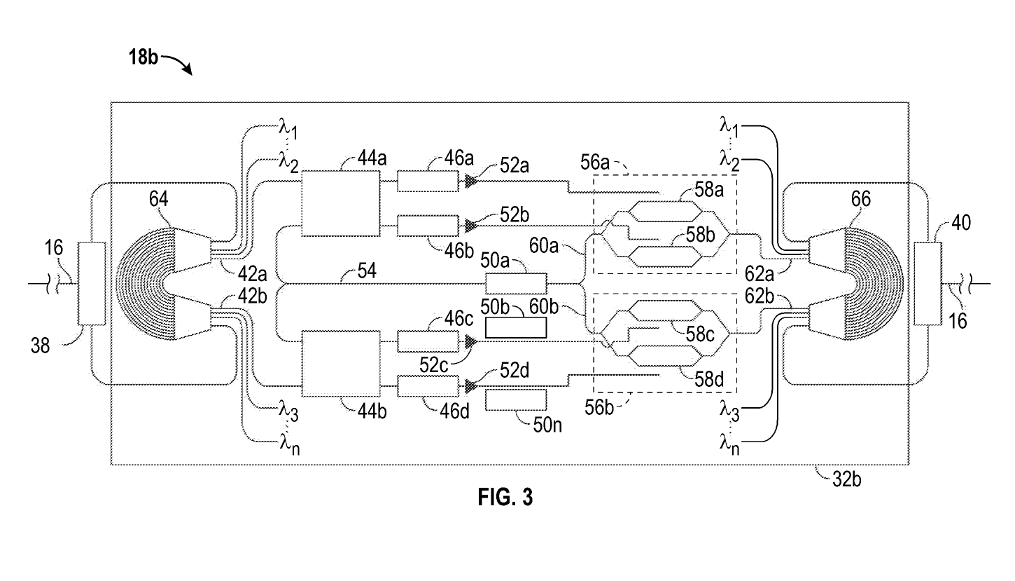

Referring now to FIG. 3, shown therein is an exemplary embodiment of a PIC-based phase conjugation device 18b. The PIC-based phase conjugation device 18b may be implemented similarly to the PIC-based phase conjugation device 18a, with the exception that the PIC-based phase conjugation device 18b is configured to phase conjugate multiple wavelength input light signals, such as wavelength division multiplexed input light signals. The PIC-based phase conjugation device 18b includes a first array waveguide grating 64, and a second array waveguide grating 66, and integrated on a common substrate 32b.

The implementation and operation of the components of the PIC-based phase conjugation device 18b may be similar to the operation of the phase conjugation device 18a, except that the first array waveguide grating 64 may be used to separate a wavelength division multiplexed input light signal having two or more wavelengths into two or more input light signals having wavelengths λ₁-λₙ, each of which may be phase conjugated as described above with respect to the phase conjugation device 18a. The resulting phase conjugated output signals for each wavelength λ₁-λₙ may then be combined into a single phase-conjugated output light signal by the second array waveguide grating 66, for example.

For each incoming wavelength λ₁-λₙ separated by the first array waveguide grating 64 from the input light signal having multiple wavelengths, a first 90° optical hybrid 44a, a second 90° optical hybrid 44b, a first photodetector 46a, a second photodetector 46b, a third photodetector 46c, a fourth photodetector 46d, a local oscillator 50a, an electrical signal amplifier 52a-d, a first phase modulator 56a, and a second phase modulator 56b, may be used to phase conjugate each of the separated input light signal wavelengths λ₁-λₙ by swapping the I component and the Q component of the input TM signal and the input TE signal as described above with reference to the PIC-based phase conjugation device 18a, for example. The second array waveguide grating 66 may then be used to recombine the two or more wavelengths λ₁-λₙ into a phase conjugated output light signal.

To that end, one, two, three, or multiple groups of the first 90° optical hybrid 44a, the second 90° optical hybrid 44b, the first photodetector 46a, the second photodetector 46b, the third photodetector 46c, the fourth photodetector 46d, the local oscillator 50a, the electrical signal amplifiers 52a-d, the first phase modulator 56a, and the second phase modulator 56b, may be used for each wavelength λ₁-λₙ, as will be understood by a person of ordinary skill in the art having the benefit of the instant disclosure, for example. For example, the first electrical output signal indicative of the I component of the input TM signal may be provided to a Q input of the first phase modulator 56a, and the second electrical output signal indicative of the I component of the input TM signal may be provided to an I input of the first phase modulator 56a. Similarly, the third electrical output signal indicative of the I component of the input TE signal may be provided to a Q input of the second phase modulator 56b and the fourth electrical signal indicative of the Q component of the input TE signal may be provided to an I input of the second phase modulator 56b, for example.

Because different wavelengths may be affected differently by the imperfections in the optical fiber, the information carried by the multiple wavelengths of the incoming light signal may optionally be inverted relative to the information carried by the multiple wavelengths of the phase conjugated output light signal during the phase conjugation carried out by the phase conjugation device 18b. For example, the input light signal may include wavelengths λ₁-λ₁₀, each wavelength having an input TM signal and an input TE signal, and each input TM signal having an I component and a Q component, and each input TE signal having an I component and a Q component. The input light signal may be separated into individual input light signals having wavelengths λ₁-λ₁₀ by the first array waveguide grating 64. Ten groups of the first 90° optical hybrid 44a, the second 90° optical hybrid 44b, the first photodetector 46a, the second photodetector 46b, the third photodetector 46c, the fourth photodetector 46d, the local oscillator 50a, the electrical signal amplifiers 52a-d, the first phase modulator 56a, and the second phase modulator 56b, may be electrically or optically coupled with one another such that they are configured to invert the information carried by the wavelengths λ₁-λ₁₀, for example. The first photodetector 46a, the second photodetector 46b, the third photodetector 46c, and the fourth photodetector 46d of a first group used for λ₁ may be electrically coupled with the first phase modulator 56a and the second phase modulator 56b of a second group used for λ₁₀, for example. At the same time, the first photodetector 46a, the second photodetector 46b, the third photodetector 46c, and the fourth photodetector 46d of the second group used for λ₁₀ may be electrically coupled with the first phase modulator 56a, and the second phase modulator 56b of the first group used for λ₁, for example. A first electrical signal indicative of the I component of the input TM signal of the λ₁ input light signal may be used to modulate a Q component of the output TM signal of the λ₁₀ output light signal, a second electrical signal indicative of the Q component of the input TM signal of the λ₁ input light signal may be used to modulate an I component of the output TM signal of the λ₁₀ output light signal, a third electrical signal indicative of the I component of the input TE signal of the λ₁ input light signal may be used to modulate a Q component of the output TE signal of the λ₁₀ output light signal, a fourth electrical signal indicative of the Q component of the input TE signal of the λ₁ input light signal may be used to modulate an I component of the output TE signal of the λ₁₀ output light signal, by the phase conjugation device 18b, for example. The respective I and Q components of the respective TM and TE signals may be swapped and modulated as described above from the λ₂ light signal to the λ₉ light signal and from the λ₉ light signal to the λ₂ light signal, from the λ₃ light signal to the λ₇ light signal and vice versa, and so on in a similar fashion until all wavelengths have been phase conjugated and have their respective components swapped with one another. The resulting output light signal may include λ₁-λ₁₀, with the information or data carried by λ₁ of the input light signal now being carried by λ₁₀, of the phase conjugated light output signal and the information or data carried by λ₁₀ of the input light signal being carried by λ₁ of the phase conjugated output light signal, and so on for the remaining wavelengths, as will be appreciated by a person of ordinary skill in the art having the benefit of the instant disclosure.

It is to be understood that in some exemplary embodiments, the first array waveguide grating 64 may be used to separate the wavelengths λ₁-λₙ from the input transverse magnetic signal and/or may be used to combine the wavelengths λ₁-λₙ from the phase-conjugated output light signal, and the second array waveguide grating 66 may be used to separate the wavelengths λ₁-λₙ from the input transverse electric signal and/or to combine the wavelengths λ₁-λₙ from the phase-conjugated output light signal, for example.

As will be appreciated by persons of ordinary skill in the art, the phase conjugation devices 18, 18a, and/or 18b may be implemented without requiring nonlinear optics, and as being a module operating as optical fiber in—optical fiber out, with no external electrical signals. Further, decoding of the light signal is not required, or carried out with the embodiments disclosed herein, which may result in substantial hardware and energy savings.

Although the embodiments disclosed herein have been described in some detail by way of illustration and example for purposes of clarity of understanding, it will be apparent to those skilled in the art that certain changes and modifications may be practiced without departing from the spirit and scope of the embodiments disclosed herein. As such, those skilled in the art will appreciate that the conception upon which this disclosure is based may readily be utilized as a basis for the designing of other structures, methods, and systems for phase conjugating an input light signal. As such, it should be understood that the embodiments disclosed herein are not limited to the specific embodiments described herein, including the details of construction and the arrangements of the components as set forth in the above description or illustrated in the drawings. Further, it should be understood that the phraseology and terminology employed herein are for the purpose of description and should not be regarded as limiting.

As it will be appreciated by persons of ordinary skill in the art, changes may be made in the construction and the operation of the various components, elements and assemblies described herein or in the steps or the sequence of steps of the methods described herein without departing from the broad scope of the embodiments disclosed herein.

From the above description, it is clear that the embodiments disclosed herein are well configured to carry out the objects and to attain the advantages mentioned herein as well as those inherent advantages. While presently preferred embodiments have been described for purposes of this disclosure, it will be understood that numerous changes may be made which will readily suggest themselves to those skilled in the art and which are accomplished within the scope and coverage disclosed and claimed herein.

What is claimed is:

1. A photonic integrated circuit device comprising:
a substrate;
a receiver integrated in the substrate having at least one optical input line, a local oscillator, a first electrical output line, a second electrical output line, a third electrical output line, and a fourth electrical output line;
a transmitter integrated in the substrate having a first input line in electrical communication with the first electrical output line, a second input line in electrical communication with the second electrical output line, a third input line in electrical communication with the third electrical output line, and a fourth input line in electrical communication with the fourth electrical output line, the transmitter having a first optical output line and a second optical output line; and
wherein the receiver is configured to receive an input light signal having an input TM signal, and input TE signal, and to convert the input light signal into a first electrical signal outputted to the first electrical output line, a second electrical signal outputted to the second electrical output line, a third electrical signal outputted to the third electrical output line, and a fourth electrical signal outputted to the fourth electrical output line, and wherein the transmitter is configured to receive the first, second, third, and fourth electrical signals and to modulate a first output light signal with the first electrical signal and the second electrical signal and output a first phase conjugated output light signal on the first optical output line, and to modulate the first output light signal with the third electrical signal and the fourth electrical signal and output a second phase conjugated output light signal on the second optical output line, and
wherein the first electrical signal comprises information indicative of an I component of the input TM signal, the second electrical signal comprises information indicative of a Q component of the input TM signal, the third electrical signal comprises information indicative of an I component of the input TE signal, and the fourth electrical signal comprises information indicative of a Q component of the input TE signal.

2. The photonic integrated circuit device of claim 1, wherein the receiver further comprises a polarized beam splitter configured to separate the input TM signal from the input TE signal of the input light signal, and wherein the transmitter further comprises a polarized beam combiner configured to combine the first phase conjugated output light signal and the second phase conjugated output light signal into a third phase conjugated output light signal.

3. The photonic integrated circuit device of claim 1, wherein the receiver is a coherent receiver.

4. A photonic integrated circuit device, comprising:
a substrate;
a polarization beam splitter configured to split an input light signal into an input TM signal having a first I component and a first Q component, and an input TE signal having a second I component and a second Q component;
a first 90° optical hybrid integrated into the substrate and optically coupled to the polarization beam splitter, such that the input TM signal may be provided to the first 90° optical hybrid, the first 90° optical hybrid configured to separate the input TM signal into the first I component and the first Q component;
a first photodetector integrated into the substrate in optical communication with the first 90° optical hybrid and configured to detect the first I component and to output a first electrical signal indicative of the first I component to a first electrical output line;
a second photodetector integrated into the substrate in optical communication with the first 90° optical hybrid and configured to detect the first Q component and to output a second electrical signal indicative of the first Q component to a second electrical output line;
a second 90° optical hybrid integrated into the substrate optically coupled to the polarization beam splitter, such that the input TE signal may be provided to the second 90° optical hybrid, the second 90° optical hybrid configured to separate the input TE signal into the second I component and the second Q component;
a third photodetector integrated into the substrate in optical communication with the second 90° optical hybrid and configured to detect the second I component and to output a third electrical signal indicative of the second I component to a third electrical output line;
a fourth photodetector integrated into the substrate in optical communication with the second 90° optical hybrid and configured to detect the second Q component and to output a fourth electrical signal indicative of the second Q component to a fourth electrical output line;
a first phase modulator integrated into the substrate and having a first Q input electrically coupled with the first electrical output line and a first I input coupled with the second electrical output line, the first phase modulator configured to output a first output light signal having a first output I component and a first output Q component;
a second phase modulator integrated into the substrate and having a second Q input electrically coupled with the third electrical output line and a second I input electrically coupled with the fourth electrical output line, the second phase modulator configured to output a second output light signal having a second output I component and a second output Q component;
a polarization beam combiner optically coupled with the first phase modulator and with the second phase modulator, the polarization beam combiner configured to combine the first output light signal and the second output light signal into a phase conjugated output light signal; and
wherein the photonic integrated circuit device is configured to carry out light signal phase conjugation when operably connected to an optical signal transmission link.

5. A method, comprising:
operably connecting an optical transmission link to one or more photonic integrated circuit device comprising:
a substrate;
a receiver integrated in the substrate having at least one optical input line, a local oscillator, a first electrical output line, a second electrical output line, a third electrical output line, and a fourth electrical output line;
a transmitter integrated in the substrate in electrical communication with the first, second, third, and fourth electrical output lines and having a first optical output line and a second optical output line; and
wherein the receiver is configured to receive an input light signal having an input TM signal, and input TE signal, and to convert the input light signal into a first electrical signal outputted to the first electrical output line, a second electrical signal outputted to the second electrical output line, a third electrical signal outputted to the third electrical output line, and a fourth electrical signal outputted to the fourth electrical output line, and wherein the transmitter is configured to receive the first, second, third, and fourth electrical signals and to modulate a first output light signal with the first electrical signal and the second electrical signal and output a first phase conjugated output light signal on the first optical output line, and to modulate the first output light signal with the third electrical signal and the fourth electrical signal and output a second phase conjugated output light signal on the second optical output line.

6. The method of claim 5, wherein the first electrical signal comprises information indicative of an I component of the input TM signal, the second electrical signal comprises information indicative of a Q component of the input TM signal, the third electrical signal comprises information indicative of an I component of the input TE signal, and the fourth electrical signal comprises information indicative of a Q component of the input TE signal.

7. The method of claim 6, wherein the transmitter is configured to receive the first electrical signal indicative of the I component from the input TM signal and modulate a Q component of the first output light signal, receive the second electrical signal indicative of the Q component from the input TM signal and modulate an I component of the first output light signal, receive the third electrical signal indicative of the I component from the input TE signal and modulate a Q component of the second output light signal, and receive the fourth electrical signal indicative of the Q component from the input TE signal and modulate an I component of the second output light signal.

8. The method of claim 5, wherein the receiver further comprises a polarized beam splitter configured to separate the input TM signal from the input TE signal of the input light signal, and wherein the transmitter further comprises a polarized beam combiner configured to combine the first phase conjugated output light signal and the second phase conjugated output light signal into a third phase conjugated output light signal.

9. The method of claim 5, wherein the receiver is a coherent receiver.

10. A method, comprising:
receiving a TM component and a TE component of an input light signal by a receiver of a photonic integrated circuit device;
phase conjugating the input light signal to create a phase conjugated output light signal by the photonic integrated circuit device; and
outputting the phase conjugated output light signal.

11. The method of claim 10, wherein the step of receiving the TM component and the TE component includes splitting the input light signal into the TM component and the TE component via a polarization beam splitter.

12. The method of claim 10, wherein the step of phase conjugating the input light signal by the photonic integrated circuit device includes a transmitter:
receiving a first electrical signal indicative of an I component of the TM component of the input light signal and modulating a Q component of a first output light signal with the first electrical signal;
receiving a second electrical signal indicative of a Q component of the TM component of the input light signal and modulating a Q component of the first output light signal with the second electrical signal;
receiving a third electrical signal indicative of an I component of the TE component of the input light signal and modulating a Q component of a second output light signal with the third electrical signal; and
receiving a fourth electrical signal indicative of a Q component of the input light signal and modulating an I component of the second output light signal with the fourth electrical signal.
